(19) United States
(12) Patent Application Publication
(10) Pub. No.: US 2015/0114131 A1
(43) Pub. Date: Apr. 30, 2015

(54) BONDING FORCE TEST DEVICE

(71) Applicant: SAMSUNG ELECTRO-MECHANICS CO., LTD., Suwon-si (KR)

(72) Inventors: Jin Uk Cha, Suwon-si (KR); Gyu Seok Kim, Suwon-si (KR); Eun Ju Yang, Suwon-si (KR); Mi Yang Kim, Suwon-si (KR); Suk Jin Ham, Suwon-si (KR)

(73) Assignee: SAMSUNG ELECTRO-MECHANICS CO., LTD., Suwon-si (KR)

(21) Appl. No.: 14/188,183

(22) Filed: Feb. 24, 2014

(30) Foreign Application Priority Data
Oct. 31, 2013 (KR) 10-2013-0131429

(51) Int. Cl. G01N 3/24; H02N 2/10; G01N 3/04

(52) U.S. Cl. CPC G01N 3/24; G01N 3/04; H02N 2/10
USPC 73/842

(57) ABSTRACT

Disclosed herein is a bonding force test device, including: a holder mounted with a sample to which a plurality of subjects to be tested are bonded; a rotating part rotating the holder; and a fixing tip disposed in a direction in which the fixing tip faces the holder, wherein at the time of rotating the holder, the fixing tip contacts any one of the subjects to be tested in the sample and a shearing stress is applied to a bonded portion between the fixing tip and any one subject to be tested.

### CROSS REFERENCE TO RELATED APPLICATION

This application claims the benefit of Korean Patent Application No. 10-2013-0131429, filed on Oct. 31, 2013, entitled “Bonding Force Test Device”, which is hereby incorporated by reference in its entirety into this application.

### BACKGROUND OF THE INVENTION

1. Technical Field

The present invention relates to a bonding force test device.

2. Description of the Related Art

Currently, most of electronic components have a multilayer structure. When an interfacial bonding force between components or products which are stacked in a multilayer in one process is weak, defects, such as delamination, may occur in the next process and a delamination defect problem may occur during the actual use of a user.

In this case, the interfacial bonding force may be generated by molecular binding or atomic binding where different materials are bonded and may be generated by surface roughness. The above-mentioned two factors have a large effect on the bonding force. In particular, in the case of the substrate, the interfacial bonding force between polymers and between polymer and metal may be considered as a very important factor in the process or the actual use.

Further, a phenomenon observed due to the delamination of the two layers from the macroscopic viewpoint occurs due to delamination or cracks in two very small regions from the microscopic viewpoint. Since energy larger than energy required to deliver cracks or delamination is consumed, an understanding of an occurrence mechanism of cracks or delamination in a micro region may be essentially required to figure out or solve the phenomenon of defects.

However, even though the bonding force has a large effect on the performance or reliability of products, a method or an apparatus for substantially estimating the bonding force in the multilayer structure of the micro region is not yet present.

### PRIOR ART DOCUMENT

### Patent Document

(Patent Document 1) Korean Patent Laid-Open Publication No. 2012-0103110

### SUMMARY OF THE INVENTION

The present invention has been made in an effort to provide a bonding force test device capable of testing a bonding force in a micro region and a multilayer structure.

According to a preferred embodiment of the present invention, there is provided a bonding force test device, including: a holder mounted with a sample to which a plurality of subjects to be tested are bonded; a rotating part rotating the holder; and a fixing tip disposed in a direction in which the fixing tip faces the holder, wherein at the time of rotating the holder, the fixing tip contacts any one of the subjects to be tested in the sample and a shearing stress is applied to a bonded portion between the fixing tip and any one subject to be tested.

The holder may include: a cover part having the sample mounted thereon; a coupling frame having the cover part coupled therewith; and a fixing member fixing the cover part to the coupling frame.

The cover part may be provided with an insertion groove into which one portion of the sample is inserted.

The insertion groove may have a rectangular pillar shape.

The fixing member may be a screw.

The coupling frame may be provided with a coupling hole through which the screw penetrates, and the cover part may be provided with a screw groove with which the screw coupled with the coupling hole is coupled.

The rotating part may be a motor.

A rotating shaft of the motor may be vertically disposed with respect to a longitudinal direction of the fixing tip.

The rotating part may be a piezo ultrasonic motor.

The bonding force test device may further include: a body in which the holder, the rotating part, and the fixing tip are supported.

The bonding force test device may further include: a stress sensing part sensing a force applied to the fixing tip.

According to another preferred embodiment of the present invention, there is provided a bonding force test device, including: a body; a holder disposed at one portion of the body and mounted with a sample; a rotating part rotating the holder; and a fixing tip disposed at the other portion of the body and disposed in a direction in which the fixing tip faces the holder, wherein the rotating part rotates the holder to contact the sample to the fixing tip and a shearing stress applied to the sample is measured.

The holder may include: a cover part having the sample mounted thereon; a coupling frame having the cover part coupled therewith; and a fixing member fixing the cover part to the coupling frame.

The cover part may be provided with an insertion groove into which one portion of the sample is inserted.

The fixing member may be a screw.

The coupling frame may be provided with a coupling hole through which the screw penetrates, and the cover part may be provided with a screw groove with which the screw coupled with the coupling hole is coupled.

The rotating part may be a motor.

A rotating shaft of the motor may be vertically disposed with respect to a longitudinal direction of the fixing tip.

The rotating part may be a piezo ultrasonic motor.

The bonding force test device may further include: a stress sensing part sensing a force applied to the fixing tip.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram illustrating a bonding force test device according to a preferred embodiment of the present invention;

FIG. 2 is a plan view illustrating main components of the bonding force test device according to the preferred embodiment of the present invention;

FIG. 3 is a cross-sectional view illustrating the main components of the bonding force test device according to the preferred embodiment of the present invention;

FIG. 4 is a side view exemplarily illustrating a state before the bonding force test device according to the preferred embodiment of the present invention applies a shearing stress to a sample;

FIG. 5 is a side view exemplarily illustrating a state in which the bonding force test device according to the preferred embodiment of the present invention applies a shearing stress to a sample; and

FIG. 6 is a cross-sectional view exemplarily illustrating a state in which the sample illustrated in FIG. 5 is mounted in a holder.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

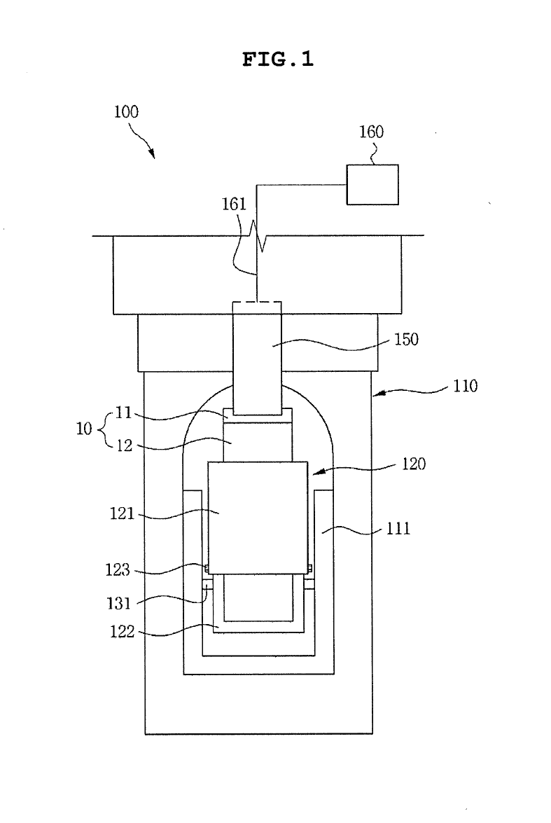

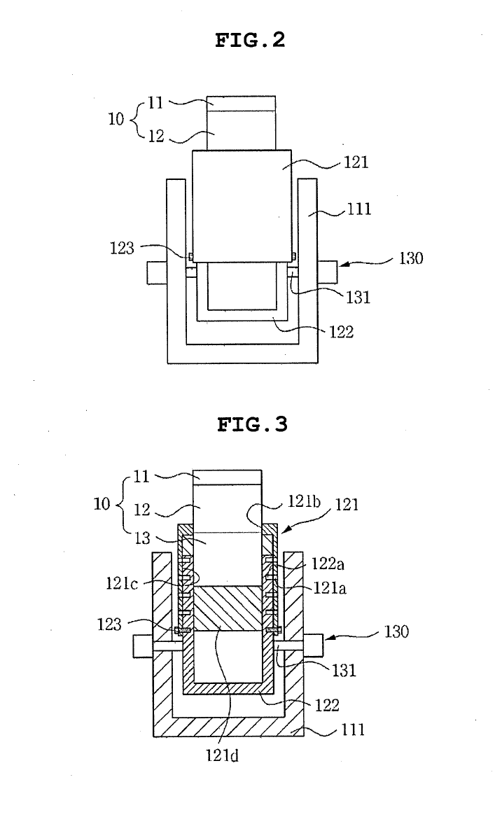

FIG. 1 is a conceptual diagram illustrating a bonding force test device according to a preferred embodiment of the present invention, FIG. 2 is a plan view illustrating main components of the bonding force test device according to the preferred embodiment of the present invention, and FIG. 3 is a cross-sectional view illustrating the main components of the bonding force test device according to the preferred embodiment of the present invention.

Referring to FIGS. 1 and 2, a bonding force test device 100 according to a preferred embodiment of the present invention may include a holder 120 mounted with a substrate, a rotating part 130, and a fixing tip 150.

Hereinafter, the bonding force test device 100 according to the preferred embodiment of the present invention will be described in more detail with reference to FIGS. 1 to 6.

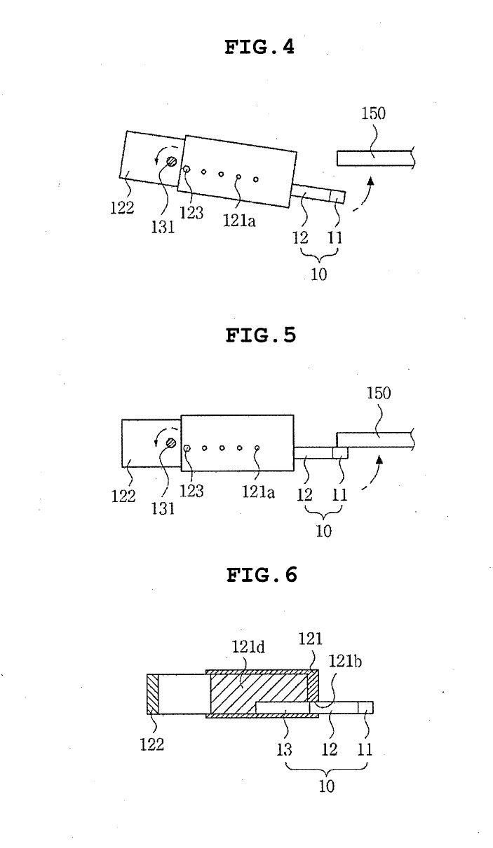

FIG. 4 is a side view exemplarily illustrating a state before the bonding force test device 100 according to the preferred embodiment of the present invention applies a shearing stress to a sample, FIG. 5 is a side view exemplarily illustrating a state in which the bonding force test device according to the preferred embodiment of the present invention applies a shearing stress to a sample, and FIG. 6 is a cross-sectional view exemplarily illustrating a state in which the sample illustrated in FIG. 5 is mounted in a holder.

Referring to FIGS. 2 and 3, the holder 120 is mounted with a sample 10 to which a plurality of subjects 11, 12, and 13 to be tested are bonded.

Further, the holder 120 includes a cover part 121 having the sample 10 mounted thereon, a coupling frame 122 having the cover part 121 coupled therewith, and a fixing member 123 which fixes the cover part 121 to the coupling frame 122.

Referring to FIGS. 3 and 6, the cover part 121 is provided with an insertion groove 121b into which a portion of the sample 10 is inserted. In this case, the insertion groove 121b may have a rectangular pillar shape, but the shape of the insertion groove 121b of the bonding force test device 100 according to the preferred embodiment of the present invention is not limited thereto.

Further, the cover part 121 is provided with a coupling groove 121c with which one portion of the coupling frame 122 is coupled. In this case, an end of the coupling frame 122 is guided along an inner wall of the coupling groove 121c to be coupled with the cover part 121. Here, the coupling groove 121c may be formed to have a shape corresponding to the coupling frame 122.

Further, the cover part 121 may be coupled with a coupling hole 121a by the fixing member 123 penetrating through the coupling hole 121a. In this case, the cover part 121 may be provided with a plurality of coupling grooves 121c along a longitudinal direction of the cover part 121. Here, the longitudinal direction of the cover part 121 may be a direction in which the cover part 121 is coupled with the coupling frame 122.

Meanwhile, the cover part 121 includes a filling part 121d formed therein and may be provided with the coupling hole 121a and the insertion groove 121b.

Referring to FIG. 3, the fixing member 123 is a screw and the coupling frame 122 is provided with a screw groove 122a so that the screw of the fixing member 123 may be screw-connected with a screw groove 122a of the coupling frame 122. In this case, the screw of the fixing member 123 is screw-connected with the screw groove 122a of the coupling frame 122 through the coupling hole 121a of the cover part 121 to fix the cover part 121 to the coupling frame 122.

Further, the plurality of screw grooves 122a may be disposed along a longitudinal direction of the coupling frame 122. In this case, the longitudinal direction of the coupling frame 122 may be a direction in which the coupling frame 122 is coupled with the cover part 121.

Therefore, the cover part 121 moves along an outer surface of the coupling frame 122 having the coupling groove 121c coupled therewith, such that the cover part 121 may be fixed to the coupling frame 122 at the desired position by the fixing member 123. Therefore, a position of the sample 10 may be controlled and fixed.

Meanwhile, the coupling frame 122 may have, for example, a “ [symbol] ” shape, but the shape of the coupling frame 122 of the bonding force test device 100 according to the preferred embodiment of the present invention is not limited thereto.

Referring to FIGS. 2, 4, and 5, the rotating part 130 has an end coupled with the coupling frame 122 to rotate the holder 120. In this case, the rotating part 130 is a motor and thus a rotating shaft 131 may be coupled with both sides of the coupling frame 122. Therefore, the rotating shaft 131 rotates by driving the motor and thus the coupling frame 122 may rotate.

Further, referring to FIGS. 1 and 3, the rotating shaft 131 may be vertically disposed with respect to the longitudinal direction of the fixing tip 150. In this case, the longitudinal direction of the fixing tip 150 may be a direction in which the fixing tip 150 faces the sample 10.

Further, the motor of the rotating part 130 may be, for example, a piezo ultrasonic motor, but a kind of the rotating part 130 of the bonding force test device 100 according to the preferred embodiment of the present invention is not necessarily limited thereto.

Meanwhile, the bonding force test device 100 according to the preferred embodiment of the present invention may further include a body 110 in which the holder 120, the rotating part 130, and the fixing tip 150 are supported.

Further, one portion of the body 110 is provided with a mounting part 111, such that the holder 120 and the rotating part 130 may be mounted on a mounting part 111 which is one portion of the body 110. In this case, the mounting part 111 may have, for example, a “ [symbol] ” shape, but the shape of the mounting part 111 of the bonding force test device 100 according to the preferred embodiment of the present invention is not limited thereto.

In this case, the holder 120 may be disposed in the mounting part 111 and the rotating part 130 may be mounted on the mounting part 111. In this case, when the rotating part 130 is formed as a motor, the rotating shaft 131 of the motor may be coupled with the coupling frame 122 of the holder 120.

The fixing tip 150 is fixed to the other portion of the body 110 and is disposed in a direction in which the fixing tip faces the holder 120. In this case, the fixing tip 150 may have, for example, a rectangular pillar shape, but the shape of the fixing tip 150 of the bonding force test device 100 according to the preferred embodiment of the present invention is not limited thereto.

Meanwhile, the bonding force test device 100 according to the preferred embodiment of the present invention may include a stress sensing part 160 which senses a force applied to the fixing tip 150. Here, the stress sensing part 160 senses the stress applied to the fixing tip 150 to be able to measure the shearing stress of the sample 10 to separate the sample 10 contacting the fixing tip 150.

Further, the stress sensing part 160 may include a stress sensing sensor which senses the stress of the fixing tip 150. In this case, the stress sensing part 160 may include a connection line 161 which electrically connects the stress sensing sensor.

Hereinafter, the operation of the bonding force test device according to the preferred embodiment of the present invention will be described.

The sample 10 is inserted into the cover part 121 of the holder 120, and then the cover part 121 is coupled with the coupling frame 122 of the holder 120. In this case, the cover part 121 is fixed to the coupling frame 122 by the fixing member 123.

Further, when the rotating part 130 rotates the holder 120, the sample 10 mounted in the holder 120 contacts the fixing tip 150 which is disposed in a direction in which the fixing tip 150 faces the sample 10. Further, when a rotating force is gradually applied to the holder 120 through the rotating part 130, the shearing stress is applied to the sample 10 and then exceeds a critical point, such that the sample 10 is cut. In this case, at the time of cutting the sample 10, the stress sensing part 160 senses the stress applied to the fixing tip 150, such that the shearing stress of the sample 10 may be measured. In this case, when any one of the subjects 11 to be tested in the sample 10 to which the plurality of subjects 11, 12, and 13 to be tested are bonded contacts the fixing tip 150 and the subject 11 to be tested and the fixing tip 150 are separated from each other by the shearing stress applied to a bonded portion therebetween, it is possible to measure the bonding force between any one subject 11 to be tested and another tested subject 12.

Therefore, when the sample 10 is bonded to the plurality of subjects 11, 12, and 13 to be tested, it is possible to precisely measure the bonding force between the respective subjects 11, 12, and 13 to be tested.

According to the preferred embodiments of the present invention, it is possible to test the bonding force in the multilayer structure.

Further, it is possible to precisely test the bonding force at the micro portion.

In addition, it is possible to reduce the test error and perform the operation and observation in real time.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A bonding force test device, comprising:
a holder mounted with a sample to which a plurality of subjects to be tested are bonded;
a rotating part rotating the holder; and
a fixing tip disposed in a direction in which the fixing tip faces the holder,
wherein at the time of rotating the holder, the fixing tip contacts any one of the subjects to be tested in the sample and a shearing stress is applied to a bonded portion between the fixing tip and any one subject to be tested.

2. The bonding force test device as set forth in claim 1, wherein the holder includes:
a cover part having the sample mounted thereon;
a coupling frame having the cover part coupled therewith; and
a fixing member fixing the cover part to the coupling frame.

3. The bonding force test device as set forth in claim 2, wherein the cover part is provided with an insertion groove into which one portion of the sample is inserted.

4. The bonding force test device as set forth in claim 3, wherein the insertion groove has a rectangular pillar shape.

5. The bonding force test device as set forth in claim 2, wherein the fixing member is a screw.

6. The bonding force test device as set forth in claim 5, wherein the coupling frame is provided with a coupling hole through which the screw penetrates, and
the cover part is provided with a screw groove with which the screw coupled with the coupling hole is coupled.

7. The bonding force test device as set forth in claim 1, wherein the rotating part is a motor.

8. The bonding force test device as set forth in claim 7, wherein a rotating shaft of the motor is vertically disposed with respect to a longitudinal direction of the fixing tip.

9. The bonding force test device as set forth in claim 1, wherein the rotating part is a piezo ultrasonic motor.

10. The bonding force test device as set forth in claim 1, further comprising:
a body in which the holder, the rotating part, and the fixing tip are supported.

11. The bonding force test device as set forth in claim 1, further comprising:
a stress sensing part sensing a force applied to the fixing tip.

12. A bonding force test device, comprising:
a body;
a holder disposed at one portion of the body and mounted with a sample;
a rotating part rotating the holder; and
a fixing tip disposed at the other portion of the body and disposed in a direction in which the fixing tip faces the holder,
wherein the rotating part rotates the holder to contact the sample to the fixing tip and a shearing stress applied to the sample is measured.

13. The bonding force test device as set forth in claim 12, wherein the holder includes:
a cover part having the sample mounted thereon;
a coupling frame having the cover part coupled therewith; and
a fixing member fixing the cover part to the coupling frame.

14. The bonding force test device as set forth in claim 13, wherein the cover part is provided with an insertion groove into which one portion of the sample is inserted.

15. The bonding force test device as set forth in claim 13, wherein the fixing member is a screw.

16. The bonding force test device as set forth in claim 13, wherein the coupling frame is provided with a coupling hole through which the screw penetrates, and
the cover part is provided with a screw groove with which the screw coupled with the coupling hole is coupled.

17. The bonding force test device as set forth in claim 12, wherein the rotating part is a motor.

18. The bonding force test device as set forth in claim 17, wherein a rotating shaft of the motor is vertically disposed with respect to a longitudinal direction of the fixing tip.

19. The bonding force test device as set forth in claim 12, wherein the rotating part is a piezo ultrasonic motor.

20. The bonding force test device as set forth in claim 12, further comprising
a stress sensing part sensing a force applied to the fixing tip.
